(19) United States
(12) Patent Application Publication
(10) Pub. No.: US 2019/0153805 A1
(43) Pub. Date: May 23, 2019

(54) CONTROL OF ELASTOMER SWELLING RATE VIA SURFACE FUNCTIONALIZATION

(71) Applicants: Rostyslav Dolog, Houston, TX (US); Darryl Ventura, Houston, TX (US); Valery Khabashesku, Houston, TX (US); Qusai Darugar, Houston, TX (US)

(72) Inventors: Rostyslav Dolog, Houston, TX (US); Darryl Ventura, Houston, TX (US); Valery Khabashesku, Houston, TX (US); Qusai Darugar, Houston, TX (US)

(73) Assignee: Baker Hughes, a GE company, LLC, Houston, TX (US)

(21) Appl. No.: 15/816,262

(22) Filed: Nov. 17, 2017

(51) Int. Cl. E21B 33/12; C09K 8/50

(52) U.S. Cl. CPC E21B 33/12; C09K 8/50

(57) ABSTRACT

A sealing system for a flow channel comprises a mandrel and a swellable article disposed about the mandrel, the swellable article comprising a swellable body containing an elastomer of ethylene propylene diene monomer, styrene butadiene rubber, polychloroprene rubber, fluorosilicone rubber, fluoroelastomers, perfluoroelastomers, isobutylene-isoprene rubber, or a combination comprising at least one of the foregoing; wherein a surface of the swellable body is functionalized with a functional group that is effective to cause the surface of the swellable body to become more oleophobic than a reference surface without the functional group.

### BACKGROUND

Isolation of downhole environments depends on the deployment of a downhole tool that effectively seals the entirety of the borehole or a portion thereof, for example, an annulus between a casing wall and production tube. Swellable packers are particularly useful in that they are capable of generating a contact force against a nearby structure when exposed to one or more downhole fluids such as water, oil, or a combination thereof. Compared with mechanically setup packers and inflatable packers, fluid-swellable packers are easier to set up.

Oil swellable packers normally contain an elastomer such as ethylene propylene diene monomer (EPDM) that expands when exposed to hydrocarbon based fluids. EPDM rubber often swells rapidly in the oil or oil based fluids and can seal a borehole within one or two days at elevated temperatures. However, under certain circumstances, it is desirable to delay the swelling of the packers to allow the operator to have more time to carry out various completion operations. Such delayed swelling period can be from several hours to a few days or weeks. Thus, alternative sealing elements having controlled swelling are desired in the art.

### BRIEF DESCRIPTION

A sealing system for a flow channel comprises a mandrel and a swellable article disposed about the mandrel, the swellable article comprising a swellable body containing an elastomer of ethylene propylene diene monomer, styrene butadiene rubber, polychloroprene rubber, fluorosilicone rubber, fluoroelastomers, perfluoroelastomers, isobutylene-isoprene rubber, or a combination comprising at least one of the foregoing; wherein a surface of the swellable body is functionalized with a functional group that is effective to cause the surface of the swellable body to become more oleophobic than a surface without the functional group.

A method of sealing using the sealing system is also disclosed. The method comprises disposing the sealing system in a wellbore; and allowing the swellable article to swell upon contact with a wellbore fluid.

A method of making a swellable article comprises forming a swellable body; and disposing a functionalized elastomer on the swellable body; the functionalized elastomer comprising a functional group that is effective to cause the surface of the swellable body to become more oleophobic than a reference surface without the functional group.

### BRIEF DESCRIPTION OF THE DRAWINGS

The following descriptions should not be considered limiting in any way. With reference to the accompanying drawings, like elements are numbered alike:

FIG. 1 is a cross-sectional view of a surface functionalized swellable article according to an embodiment of the disclosure;

FIG. 2 is a cross-sectional view of a surface functionalized swellable article which has been pre-swelled in a polar solvent;

FIG. 3 is a cross-sectional view of an exemplary sealing system having a mandrel that bears a functionalized swellable article;

FIG. 4 compares the FT-IR spectrum of unfunctionalized swellable article and a surface fluorinated swellable article; and

FIG. 5 shows the swell data profiles for unfunctionalized EPDM packer prototype, surface sulfonated EPDM packer prototype, and surface fluorinated packer prototype, when tested at 200° F. in an oil-based fluid (LVT 200).

### DETAILED DESCRIPTION

Swellable articles having controlled swelling rate are disclosed. The swellable articles are surface functionalized with a polar group to make them repulsive towards oil. Such surfaced functionalized swellable articles have delayed swelling thus providing enough time for the tool operator to relocate the swellable articles where needed. In addition, since only the surface of the swellable articles is oil repulsive, the body of the swellable articles is able to swell at an initially slow, but later accelerated swelling rate. Once the functionalized swellable articles begin to expand, the overall ratio of the polar groups to non-polar groups on the surface of the swellable articles will decrease, hence the swellable articles will be able to expand to its full capacity. This is advantageous compared to packers using a rigid outer layer to regulate the amount of well fluid that reach the elastomer body because while such packers may have a delayed swelling rate, the outer layer can prevent the elastomer body from reaching its full expansion potential and adversely affect the formation of an effective seal.

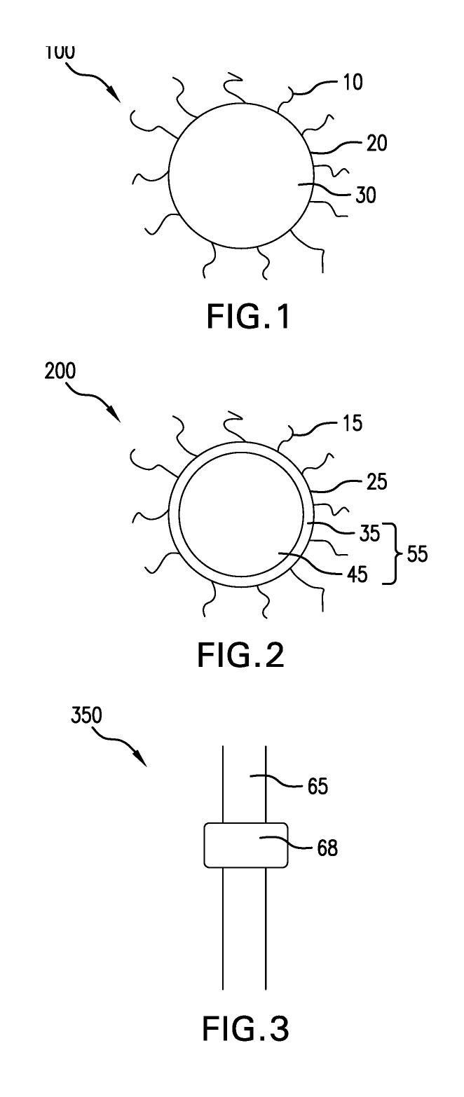

As shown in FIG. 1, a swellable article 100 includes a swellable body 30 comprising an elastomer. A surface 20 of the swellable body is functionalized with a functional group 10. The surface 20 may have a thickness of 0 to about 100 microns or greater than 0 to about 100 microns.

The swellable article provides excellent swelling volumes when exposed to oil or any oil-based fluid. Oil swellable article can contain an elastomer such as ethylene propylene diene monomer (EPDM), styrene butadiene rubber (SBR), synthetic rubbers based on polychloroprene (NEOPRENE™ polymers from DuPont), fluorosilicone rubber (FVMR), butyl rubbers (isobutylene-isoprene rubber IIR), fluoroelastomers, perfluoroelastomers and the like. In an embodiment the elastomers are crosslinked elastomers. More than one elastomer can be used. The elastomer in the surface of the swellable article can be the same or different from the elastomer in other portions of the swellable body.

Additives such as fillers, activators, antioxidants, processing acids, and curatives can be included in the swellable article. Known additives are described for example in U.S. Pat. No. 9,303,200.

A surface of the swellable body is functionalized with a functional group that is effective to cause the surface of the swellable body to become more oleophobic than a reference surface without the functional group. In an embodiment, the functional group comprises a sulfonic acid, a sulfonate, a carboxylic acid, a carboxylate, a phosphonic acid, a phosphonate, fluorinated or perfluorinated derivative thereof, or a combination comprising at least one of the foregoing. As used herein a fluorinated or perfluorinated derivative thereof means a hydrocarbon moiety (an alkyl group for example) attached to the sulfonic acid, sulfonate, carboxylic acid, carboxylate, phosphonic acid, or phosphonate in the functional group is fluorinated or perfluorinated.

The functional group can also include a fluoro group, a fluorocarbon group, or a combination comprising at least one of the foregoing. A fluorocarbon group can have 1 to 20 carbon atoms or 3 to 12 carbon atoms. Heteroatoms can be present. Fluorocarbon groups can be aromatic or aliphatic. As used herein, a fluorocarbon group can include both perfluorocarbon groups and polyfluorocarbon groups. A perfluorocarbon group refers to a group where all C—H bonds have been replaced by C—F bonds. A polyfluorocarbon group refers to a group where more than one but not all the C—H bonds are replaced by C—F bonds.

The functional group can be covalently bonded to the elastomer on the surface of the swellable body. In an embodiment, the functional group is directly bonded to the elastomer on the surface of the swellable body without any intervening atoms. As a specific example, a fluoro functional group can substitute a hydrogen atom of the elastomer on the surface of the swellable body or attach to a carbon-carbon double bond of the elastomer on the surface of the swellable body. In another embodiment, the functional group is bonded to the elastomer on the surface of the swellable body via an organic moiety having 1 to 20, 1 to 10, or 1 to 6 carbon atoms.

In an embodiment, the degree of functionalization is about 0.1 to about 90 atomic %, about 0.5 to about 70 atomic %, or about 5 to about 35 atomic % based on a heteroatom in the functional group bonded to the elastomer on the surface of the swellable body. As used herein, the thickness of the surface can be from 0 to about 100 microns. The degree of functionalization is determined by energy-dispersive X-ray spectroscopy. A layer below the surface of the swellable body can also be functionalized. The degree of functionalization can be about 1 atomic % to about 70 atomic %, about 10 atomic % to about 50 atomic %, or about 20 atomic % to about 40 atomic % for the layer which is about 100 microns to about 10 millimeters away from the surface of the swellable body. It is appreciated that not all the elastomer in the swellable body may be functionalized.

In another embodiment, the degree of functionalization is about 0.01 to about 50 wt.%, or about 1 to 10 wt.% based on the amount of an element such as S, F, O, or P in the functional group bonded to the elastomer on the outer portion of the swellable body, where the outer portion of the swellable body has a thickness of equal to or less than about 2 centimeters. The weight percent of the element can be determined by elemental analysis. It is appreciated that not all the elastomer in the swellable body is functionalized. Preferably only the elastomer on the surface or outer portion of the swellable body is functionalized.

In an embodiment, a method of making the swellable article includes forming a swellable body and then surface functionalizing the swellable body via chemical reactions. Methods to functionalize the swellable body are not particularly limited. Surface functionalization can be conducted on the crosslinked elastomers. As an example, a swellable body is surface functionalized with a sulfonic acid group by reacting the elastomer on the surface of the swellable body with acetyl sulfate following the method disclosed in Acta Materialia, 56 (2008) 4780-4788. Phosphonic acid groups can be introduced to a surface of the swellable body following similar procedures. Fluorination can be conducted with exposing a swellable body to a diluted fluorine gas at ambient pressure and a temperature of about 20° C. and 150° C. Carboxylic acid groups may be introduced by treatment with succinyl peroxide at 80-90° C. Fluorocarbon functionalization can be conducted by addition-elimination reaction with fluoroalkyl iodide. In an embodiment, the elastomer surface can be functionalized with a highly fluorinated group such as (3,3,4,4,5,5,6,6,7,7,8,8,9,9,10,10,11,11,12,12,12-heneicosafluorododecyl)phosphonic acid using perfluoalkyl phosphate. The acid groups on the surface of the swellable articles such as carboxylic acid, sulfonic acid, and phosphonic acid groups can be neutralized to provide carboxylate, sulfonate, and phosphonate groups. The acid groups can also be further crosslinked with other polar groups such as fatty acids and their fluorinated derivatives thereof to provide further tune the surface property of the swellable articles.

In another embodiment, a method of making a swellable article comprises forming a swellable body; and disposing a functionalized elastomer on the swellable body; the functionalized elastomer comprising a functional group that is effective to cause the surface of the swellable body to become more oleophobic than a reference surface without the functional group. For example, the swellable body is bonded to a functionalized elastomer layer to form the surface functionalized swellable article. The swellable body can be any conventional packer such as an EPDM packer. A functionalized elastomer layer can be made separately from a functionalized elastomer resin by molding or extruding for example. Then the functionalized elastomer layer can be wrapped around the swellable body forming the surface functionalized swellable article. A primer can be used if needed. Alternatively a functionalized elastomer can be dissolved or dispersed in a solvent then coated on a swellable body. If the functionalized elastomer is a liquid, such functionalized elastomer can be directly coated on a swellable article without using any solvent. The functional group for the functionalized elastomer layer can be the same as those disclosed herein in the context of the functional groups for the swellable body. The elastomer of the functionalized elastomer layer can be selected from the elastomers for the swellable body. For a particular swellable article the elastomer in the functionalized elastomer layer and the elastomer in the swellable body can be the same or different.

In an embodiment the surface functionalized swellable article can be pre-swelled in a polar solvent before they are deployed downhole. As shown in FIG. 2, a pre-swelled article 200 includes a swellable body 55 which has an outer portion 35 and an inner portion 45, wherein the outer portion 35 contains the polar solvent and are surface functionalized with a polar group 15. The outer portion can be in the form of a layer having an average thickness of about 0.1 mm to about 15 mm, specifically about 1.5 mm to about 15 mm, more specifically about 1.5 mm to about 7 mm. In an embodiment, the inner portion of the swellable articles is free of the polar solvent.

The polar solvent comprises a polar protic solvent, a dipolar aprotic solvent, a halogenated solvent, or a combination comprising at least one of the foregoing. Exemplary polar protic solvents include water, an alcohol such as methanol, ethanol, n-propanol, iso-propanol, n-butanol, glycol, and the like, an acid such as acetic acid. Exemplary dipolar aprotic solvents include acetone, ethyl acetate, dimethyl sulfoxide, acetonitrile, and dimethylformamide Exemplary halogenated solvents include trichloroethylene, perchloroethylene, methylene chloride, carbon tetrachloride, choloroform, methyl chloroform, dichlorofluoromethane, trichlorofluoromethane, tetrafluoromethane, difluorodichloromethane, hydrochlorofluorocarbon, ethylene dibromide, methylene chlorobromide, methyl bromide, and the like.

The surface functionalized swellable articles can be incorporated into a sealing system. The sealing system can be various downhole tools or a component of various downhole tools. In an embodiment, the sealing system is a packer, a bridge plug, a frac plug, or a component thereof. An exemplary downhole tool is shown in FIG. 3. The tool 350 includes mandrel 65 and a surface functionalized swellable article 68 disposed about the mandrel 65.

The swellable article as well as the sealing system can be used to seal a wellbore. The method comprises disposing the swellable article or sealing system in a wellbore; and allowing the swellable article to swell upon contact with a fluid.

The fluid can comprise a hydrocarbon, water, brine, an acid, a base, or a combination comprising at least one of the foregoing. The brine can include NaCl, KCl, NaBr, MgCl₂, CaCl₂, CaBr₂, ZnBr₂, NH₄Cl, sodium formate, cesium formate, and the like. The fluid can be a wellbore fluid generated downhole. Alternatively, to further control the swelling profile of swellable article, a fluid such can be introduced downhole at the time when sealing is desired. In an embodiment the fluid is a drilling fluid or a completion fluid.

Depending on the time needed to finish the completion operations, the sealing system can seal a wellbore in less than or equal to about 15 days, in less than or equal to about 10 days, or in less than or equal to about 5 days at a temperature of about 25° C. to about 300° C., about 65° C. to about 250° C., or about 65° C. to about 150° C. or about 175° C. to about 250° C., and a pressure of about 650 kPa to about 300,000 kPa. Advantageously, the sealing system seals a wellbore at least two days, at least three days, or at least five days after the sealing system is deployed downhole.

### EXAMPLES

An EPDM rubber button (1″×0.5″) was surface functionalized with sulfonic acid groups. Sulfonation was conducted according to scheme 1 following the procedure described in Acta Materialia 56 (2008) 4780-4788. Cured rubber buttons (solid) were sulfonated for 6 hours at room temperature.

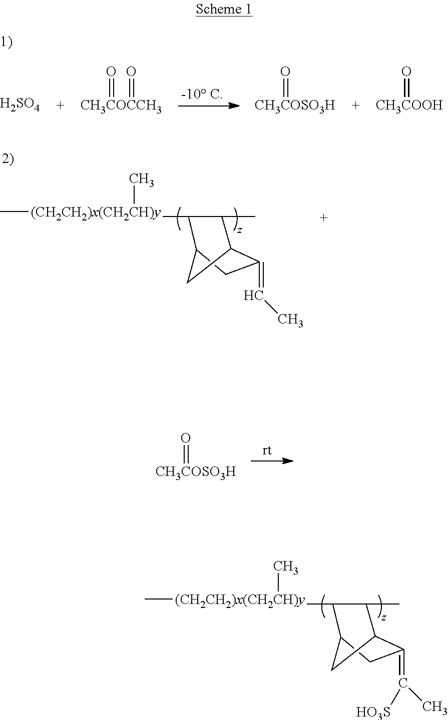

Another EPDM rubber button (1″×0.5″) was surface functionalized with fluorine groups. Fluorination was conducted by exposing fully cured EPDM (solid) button to a diluted fluorine gas at ambient pressure at a temperature of about 20° C. and 150° C. Fluorine either substituted hydrogen atoms or attached to double bonds.

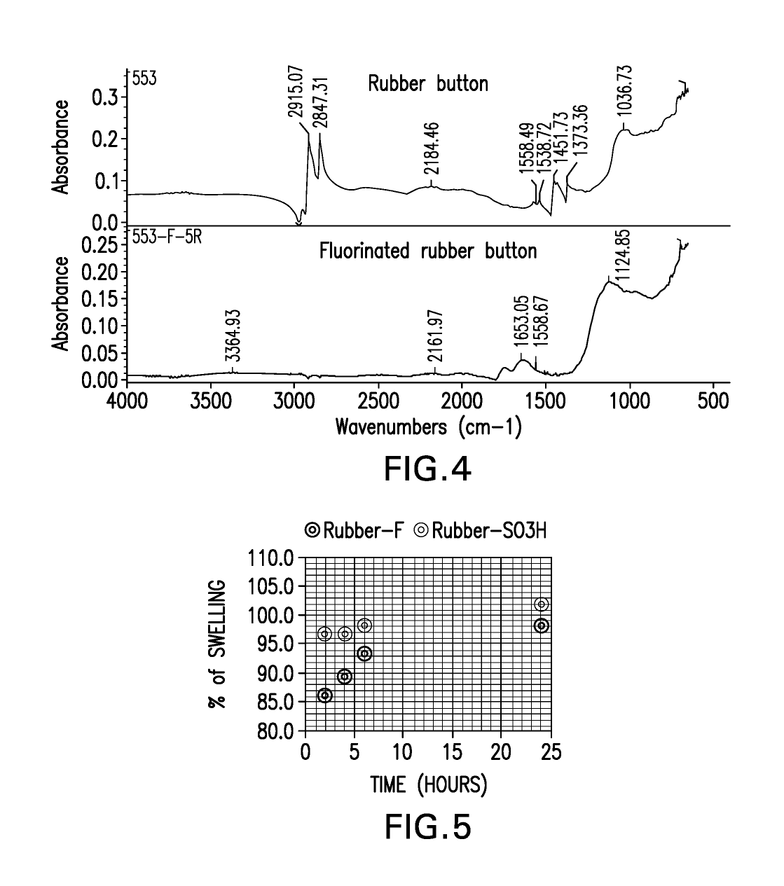

The efficiency of the functionalization was assessed via FTIR and EDS. The results are shown in FIG. 4 and the Table below. EDS demonstrated that sulfonation and fluorination resulted in approximately 1% and 30% functionalization respectively.

TABLE

| EPDM | | | EPDM-S | | | EPDM-F | | |
|---|---|---|---|---|---|---|---|---|
| Element | Wt. % | Atomic % | Element | Wt. % | Atomic % | Element | Wt. % | Atomic % |
| C K | 67 | 71.4 | C K | 88.8 | 91.8 | C K | 51.4 | 63.3 |
| N K | 18.3 | 16.7 | O K | 10 | 7.8 | O K | 4.5 | 4.2 |
| O K | 14.8 | 11.9 | S K | 1.1 | 0.4 | F K | 40.8 | 31.8 |
| S K | 0 | 0 | | | | ZnL | 3.4 | 0.8 |

Furthermore, FTIR study also clearly demonstrated efficiency of surface fluorination, when comparing IR spectra of neat rubber button with IR spectra of the button that was fluorinated: C—H stretching vibrations from —CH2- at ˜2915 cm⁻¹ and ˜2847 cm⁻¹ disappeared and a large broad peak, corresponding to C—F bond stretching at ˜1125 cm⁻¹ appeared.

Unfunctionalized EPDM buttons, surface sulfonated EPDM buttons, and surface fluorinated EPDM buttons were tested for swelling performance. Week-long swelling tests were conducted at 200° F. in LVT 200 oil to simulate downhole production fluid. The volume of the buttons was measured using densimeter after 2, 4, 6, 24, 48, and 96 hours of swelling, and the results are shown in FIG. 5. From FIG. 5 it is shown that functionalized buttons were swelling 5-15% slower than neat buttons. The swelling rate can be slowed down further by increasing functionalization (sulfonation) level.

Set forth are various embodiments of the disclosure.

Embodiment 1. A sealing system for a flow channel comprising: a mandrel and a swellable article disposed about the mandrel, the swellable article comprising a swellable body containing an elastomer of ethylene propylene diene monomer, styrene butadiene rubber, polychloroprene rubber, fluorosilicone rubber, fluoroelastomers, perfluoroelastomers, isobutylene-isoprene rubber, or a combination comprising at least one of the foregoing; wherein a surface of the swellable body is functionalized with a functional group that is effective to cause the surface of the swellable body to become more oleophobic than a reference surface without the functional group.

Embodiment 2. The sealing system of any one of the preceding embodiments, wherein the functional group comprises a sulfonic acid, a sulfonate, a carboxylic acid, a carboxylate, a phosphonic acid, a phosphonate, a fluorinated or perfluorinated derivative thereof, or a combination comprising at least one of the foregoing.

Embodiment 3. The sealing system of any one of the preceding embodiments, wherein the functional group comprises a fluoro group, a fluorocarbon group, or a combination comprising at least one of the foregoing.

Embodiment 4. The sealing system of any one of the preceding embodiments, wherein the functional group comprises a sulfonic group, carbonic group, or phosphonic group crosslinked with a fatty acid or a fluorinated or perfluorinated derivative thereof.

Embodiment 5. The sealing system of any one of the preceding embodiments, wherein the functional group comprises a fluoro group which substitutes a hydrogen atom of the elastomer on the surface of the swellable body or attaches to a carbon-carbon double bond of the elastomer on the surface of the swellable body.

Embodiment 6. The sealing system of any one of the preceding embodiments, wherein the functional group comprises a perfluoroalkyl group, a polyfluoroalkyl group, or a combination comprising at least one of the foregoing.

Embodiment 7. The sealing system of any one of the preceding embodiments, wherein the degree of functionalization is about 0.1 atomic % to about 90 atomic % based on a hetero atom in the functional group bonded to the elastomer on the surface of the swellable body.

Embodiment 8. The sealing system of any one of the preceding embodiments, wherein the functional group is covalently bonded to the elastomer on the surface of the swellable body.

Embodiment 9. The sealing system of any one of the preceding embodiments, wherein the functional group is directly bonded to the elastomer on the surface of the swellable body without any intervening atoms.

Embodiment 10. The sealing system of any one of the preceding embodiments, wherein the functional group is bonded to the elastomer on the surface of the swellable body via a moiety having 1 to 20 carbon atoms.

Embodiment 11. The sealing system of any one of the preceding embodiments, wherein the swellable body comprises an inner portion, an outer portion, and a polar solvent selectively absorbed in the outer portion of the swellable body.

Embodiment 12. The sealing system of any one of the preceding embodiments, wherein the polar solvent comprises a polar protic solvent, a dipolar aprotic solvent, a halogenated solvent, or a combination comprising at least one of the foregoing.

Embodiment 13. The sealing system of any one of the preceding embodiments, wherein the sealing system is a packer, a bridge plug, a frac plug, or a component thereof.

Embodiment 14. A method of sealing, the method comprising: disposing in a wellbore a sealing system comprising a mandrel and a swellable article disposed about the mandrel; the swellable article comprising a swellable body containing an elastomer of ethylene propylene diene monomer, styrene butadiene rubber, polychloroprene rubber, fluorosilicone rubber, fluoroelastomers, perfluoroelastomers, isobutylene isoprene rubber, or a combination comprising at least one of the foregoing; a surface of the swellable body being functionalized with a functional group that is effective to cause the surface of the swellable body more oleophobic than a reference surface without the functional group; and allowing the swelling element to swell upon contact with a downhole fluid.

Embodiment 15. The method of any one of the preceding embodiments, wherein the downhole fluid comprises a hydrocarbon, water, brine, an acid, a base, or a combination comprising at least one of the foregoing.

Embodiment 16. The method of any one of the preceding embodiments, wherein the downhole fluid is generated downhole.

Embodiment 17. The method of any one of the preceding embodiments, wherein the downhole fluid is introduced into a wellbore.

Embodiment 18. The method of any one of the preceding embodiments, wherein the downhole fluid is a completion fluid or a drilling fluid.

Embodiment 19. The method of any one of the preceding embodiments, wherein the functional group comprises a sulfonic acid, a sulfonate, a carboxylic acid, a carbonate, a phosphonic acid, a phosphonate, a fluorinated or perfluorinated derivative thereof, or a combination comprising at least one of the foregoing.

Embodiment 20. The method of any one of the preceding embodiments, wherein the functional group comprises a fluoro group, a fluorocarbon group, or a combination comprising at least one of the foregoing.

Embodiment 21. The method of any one of the preceding embodiments, wherein the swellable body comprises an inner portion, an outer portion, and a polar solvent selectively absorbed in the outer portion of the swellable body.

Embodiment 22. A method of making a swellable article comprises forming a swellable body; and disposing a functionalized elastomer on the swellable body; the functionalized elastomer comprising a functional group that is effective to cause the surface of the swellable body to become more oleophobic than a reference surface without the functional group.

All ranges disclosed herein are inclusive of the endpoints, and the endpoints are independently combinable with each other. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” The modifier “about” used in connection with a quantity is inclusive of the stated value and has the meaning dictated by the context (e.g., it includes the degree of error associated with measurement of the particular quantity).

What is claimed is:

1. A sealing system for a flow channel comprising:
a mandrel and
a swellable article disposed about the mandrel,
the swellable article comprising a swellable body containing an elastomer of ethylene propylene diene monomer, styrene butadiene rubber, polychloroprene rubber, fluorosilicone rubber, fluoroelastomers, perfluoroelastomers, isobutylene-isoprene rubber, or a combination comprising at least one of the foregoing;
wherein a surface of the swellable body is functionalized with a functional group that is effective to cause the surface of the swellable body to become more oleophobic than a reference surface without the functional group.

2. The sealing system of claim 1, wherein the functional group comprises a sulfonic acid, a sulfonate, a carboxylic acid, a carboxylate, a phosphonic acid, a phosphonate, a fluorinated or perfluorinated derivative thereof, or a combination comprising at least one of the foregoing.

3. The sealing system of claim 1, wherein the functional group comprises a fluoro group, a fluorocarbon group, or a combination comprising at least one of the foregoing.

4. The sealing system of claim 1, wherein the functional group comprises a sulfonic group, carbonic group, or phosphonic group crosslinked with a fatty acid or a fluorinated or perfluorinated derivative thereof.

5. The sealing system of claim 1, wherein the functional group comprises a fluoro group which substitutes a hydrogen atom of the elastomer on the surface of the swellable body or attaches to a carbon-carbon double bond of the elastomer on the surface of the swellable body.

6. The sealing system of claim 1, wherein the functional group comprises a perfluoroalkyl group, a polyfluoroalkyl group, or a combination comprising at least one of the foregoing.

7. The sealing system of claim 1, wherein the degree of functionalization is about 0.1 atomic % to about 90 atomic % based on a hetero atom in the functional group bonded to the elastomer on the surface of the swellable body.

8. The sealing system of claim 1, wherein the functional group is covalently bonded to the elastomer on the surface of the swellable body.

9. The sealing system of claim 1, wherein the functional group is directly bonded to the elastomer on the surface of the swellable body without any intervening atoms.

10. The sealing system of claim 1, wherein the functional group is bonded to the elastomer on the surface of the swellable body via a moiety having 1 to 20 carbon atoms.

11. The sealing system of claim 1, wherein the swellable body comprises an inner portion, an outer portion, and a polar solvent selectively absorbed in the outer portion of the swellable body.

12. The sealing system of claim 11, wherein the polar solvent comprises a polar protic solvent, a dipolar aprotic solvent, a halogenated solvent, or a combination comprising at least one of the foregoing.

13. The sealing system of claim 1, wherein the sealing system is a packer, a bridge plug, a frac plug, or a component thereof.

14. A method of sealing, the method comprising:
disposing in a wellbore a sealing system comprising
a mandrel and
a swellable article disposed about the mandrel;
the swellable article comprising a swellable body containing an elastomer of ethylene propylene diene monomer, styrene butadiene rubber, polychloroprene rubber, fluorosilicone rubber, fluoroelastomers, perfluoroelastomers, isobutylene isoprene rubber, or a combination comprising at least one of the foregoing;
a surface of the swellable body being functionalized with a functional group that is effective to cause the surface of the swellable body more oleophobic than a reference surface without the functional group; and
allowing the swellable article to swell upon contact with a downhole fluid.

15. The method of claim 14, wherein the downhole fluid comprises a hydrocarbon, water, brine, an acid, a base, or a combination comprising at least one of the foregoing.

16. The method of claim 14, wherein the downhole fluid is generated downhole.

17. The method of claim 14, wherein the downhole fluid is introduced into a wellbore.

18. The method of claim 14, wherein the downhole fluid is a completion fluid or a drilling fluid.

19. The method of claim 14, wherein the functional group comprises a sulfonic acid, a sulfonate, a carboxylic acid, a carbonate, a phosphonic acid, a phosphonate, a fluorinated or perfluorinated derivative thereof, or a combination comprising at least one of the foregoing.

20. The method of claim 14, wherein the functional group comprises a fluoro group, a fluorocarbon group, or a combination comprising at least one of the foregoing.

21. The method of claim 14, wherein the swellable body comprises an inner portion, an outer portion, and a polar solvent selectively absorbed in the outer portion of the swellable body.

22. A method of making a swellable article comprising
forming a swellable body; and
disposing a functionalized elastomer on the swellable body;
the functionalized elastomer comprising a functional group that is effective to cause the surface of the swellable body to become more oleophobic than a reference surface without the functional group.
